(19) United States
(12) Patent Application Publication
(10) Pub. No.: US 2022/0346504 A1
(43) Pub. Date: Nov. 3, 2022

(54) DETERMINING PROPERTIES OF OUTSOLES

(71) Applicant: HEWLETT-PACKARD DEVELOPMENT COMPANY, L.P., Spring, TX (US)

(72) Inventors: Alberto Maria CANALS POU, Sant Cugat del Valles (ES); Davinia FONT CALAFELL, Sant Cugat del Valles (ES)

(21) Appl. No.: 17/244,071

(22) Filed: Apr. 29, 2021

(51) Int. Cl. A43D 1/02; A43B 13/00; B33Y 50/00; B33Y 80/00

(52) U.S. Cl. CPC A43D 1/02; A43B 13/00; B33Y 50/00; B33Y 80/00

(57) ABSTRACT

A computer-implemented method is disclosed. The computer-implemented method comprises receiving biometric data relating to a foot of a subject. The computer-implemented method also comprises determining, based on the biometric data, properties of an outsole of an article of footwear to be manufactured for the subject. The computer-implemented method also comprises providing data defining the properties of the outsole for delivery to an additive manufacturing apparatus. An apparatus and a machine-readable medium are also disclosed.

### BACKGROUND

Additive manufacturing systems that generate three-dimensional objects on a layer-by-layer basis have been proposed as a potentially convenient way to produce three-dimensional objects.

An example of a three-dimensional object that may be generated using additive manufacturing is a part of an article of footwear. An article of footwear may comprise an insole, a midsole and an outsole.

### BRIEF DESCRIPTION OF DRAWINGS

Examples will now be described, by way of non-limiting example, with reference to the accompanying drawings, in which:

FIG. 1 is a bottom view illustration of an example of an outsole of an article of footwear;

FIG. 2 is a side view illustration of a further example of an outsole of an article of footwear;

FIG. 3 is a flowchart of an example of a method of determining properties of an outsole of an article of footwear;

FIG. 4 is a flowchart of a further example of a method of determining properties of an outsole of an article of footwear;

FIG. 5 is a schematic illustration of an example of an apparatus for establishing structural characteristics of an outsole of an article of footwear;

FIG. 6 is a schematic illustration of an example of a processor in communication with a machine-readable medium; and

FIG. 7 is a flowchart showing an example of a process for forming an outsole.

### DETAILED DESCRIPTION

An article of footwear may comprise an insole, a midsole and/or an outsole. The outsole is the component of an article of footwear that interacts with a surface (e.g. the ground) while in use, and may be considered to be the outer sole of an article of footwear (e.g. a shoe, boot, sandal, or the like). An article of footwear may comprise just an outsole, which has one side that interacts with a surface (e.g. the ground) and another side that interacts, or supports, a foot of a subject. In other examples, an outsole of an article of footwear may be attached to the midsole or the insole of the article of footwear. In such examples, the outsole may be suitable for interacting with the ground (e.g. may be manufactured from a relatively durable material) and the insole and/or midsole may be suitable for interacting with a foot of a subject (e.g. may be manufactured from a relatively soft material). An article of footwear may therefore comprise a layer or section, or multiple layers or sections (i.e. the insole, midsole and/or outsole), such that the outsole may be connected to and/or layered below the midsole, and the midsole may be connected to and/or layered below the insole. In other examples, the outsole may be connected to or layered below the insole directly (e.g. in the absence of a midsole). The outsole may form a component of some articles of footwear and may play a role in the performance of the article of footwear, for example, by helping to lower a risk of slipping, being of a flexible, lightweight and/or durable nature, or the like. These factors can be of interest when a subject wearing the article of footwear performs certain activities, such as sporting activities. For example, if the subject is running a marathon, it may be intended that their footwear comprises a lightweight material and be flexible in nature, whereas, if the subject is hiking up a mountain, it may be intended that their footwear comprises a relatively heavier or sturdier material.

Outsoles may be manufactured using a mold, and outsoles generated using a particular mold may have the same or similar properties. An alternative way to manufacture outsoles is to use additive manufacturing.

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber. According to one example, a suitable build material may be a thermoplastic polyurethane (TPU), a thermoplastic amide (TPA), polyamide 11 (PA 11), polyamide 12 (PA12), polypropylene (PP) or the like. In some examples, an article manufactured using additive manufacturing may be formed using a combination of build materials.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a slice of the three-dimensional object in accordance with the pattern.

According to one example, a suitable fusing agent may be an ink-type formulation comprising carbon black. In one example such a fusing agent may additionally comprise an infra-red light absorber. In one example such a fusing agent may additionally comprise a near infra-red light absorber. In one example such a fusing agent may additionally comprise a visible light absorber. In one example such a fusing agent may additionally comprise a UV light absorber. Examples of print agents comprising visible light enhancers are dye based colored ink and pigment based colored ink.

In other examples, coalescence may be achieved in some other manner. For example, other additive manufacturing technologies include stereolithography (SLA), selective laser sintering (SLS), fused deposition modeling (FDM), and the like.

In addition to a fusing agent, in some examples, a print agent may comprise a coalescence modifying agent (referred to as modifying or detailing agents herein after), which acts to modify the effects of a fusing agent for example by reducing or increasing coalescence or to assist in producing a particular finish or appearance to an object, and such agents may therefore be termed detailing agents. A detailing agent (also termed a “coalescence modifier agent” or “coalescing modifier agent”) may, in some examples, have a cooling effect. In some examples, the detailing agent may be used near edge surfaces of an object being printed. A coloring agent, for example comprising a dye or colorant, may in some examples be used as a fusing agent or a modifying agent, and/or as a print agent to provide a particular color for the object.

As noted above, additive manufacturing systems may generate objects (e.g. an outsole) based on structural design data. This may involve a designer generating a three-dimensional model of an object to be generated, for example using a computer aided design (CAD) application, an STL file format (i.e. a file format native to stereolithography CAD software, or the like. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

Outsoles manufactured using additive manufacturing may be tailored, such that each outsole may be customized relatively easily, by adapting the model data that the additive manufacturing apparatus uses to generate the outsole. In this way, a new mold is not constructed and used for each different design, as a three-dimensional printing apparatus is able to manufacture a new design without using a mold. Customization of an outsole may be based on various factors, such as the activity that is to be performed using the article of footwear that the outsole is to form a part of, biometric data of the subject who intends to wear the footwear, and/or personal preferences of the subject who intends to wear the footwear (e.g. with regard to aesthetics, such as color, or with regard to functionality, such as a maximum weight of the outsole). By customizing an outsole, the level of comfort experienced by the subject when wearing the footwear, or a level of performance experienced by the subject when performing an activity while wearing the footwear, may be improved, compared to an article of footwear that has not been customized, or adapted, to the subject's specific preferences. Furthermore, customization of an outsole can lead to improved durability of the outsole, and thus the associated article of footwear, for example by modifying a density of build material of the outsole, as is described in more detail below.

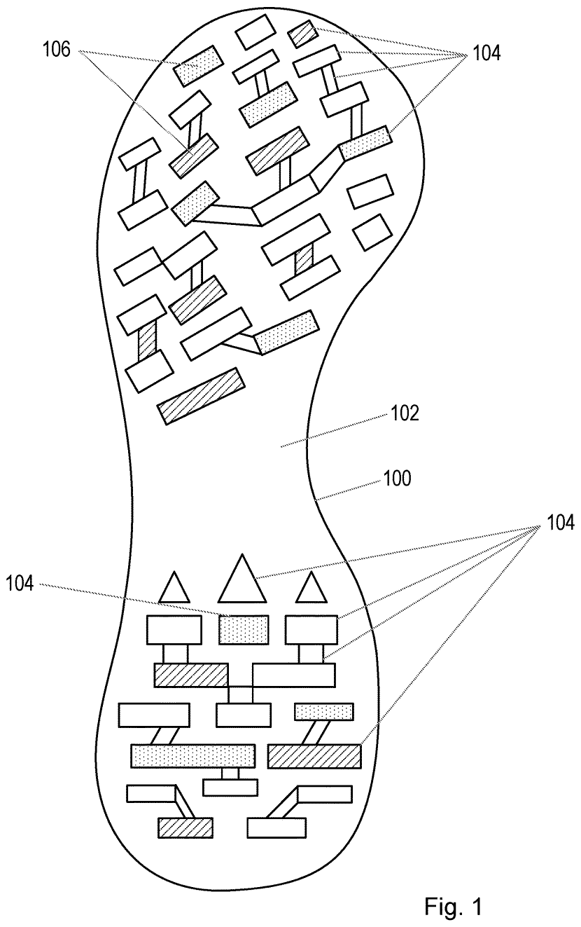

FIG. 1 is a bottom view illustration of an example of an outsole 100 of an article of footwear. The outsole 100 shown in FIG. 1 comprises a base portion 102 and a plurality of elements 104 extending from the base portion. In some examples, the plurality of elements 104 may comprise cylindrical cross-sections, rectangular cross-sections, square cross-sections, or the like. In other examples, the plurality of elements 104 may comprise a hemispherical shape. In yet further examples, the base portion 102 may comprise a plurality of recesses, or may comprise just a base portion without any protrusions (e.g. elements 104 extending from the base portion) or recesses. In some examples, the plurality of elements 104 may comprise a combination of protrusions extending from the base portion and recesses, and the elements and/or recesses may comprise a combination of shapes and sizes. The plurality of elements may be formed according to a property or a set of properties. In some examples, each element in the plurality of elements may be formed according to a separate property of a set of properties, such that the properties vary across the plurality of elements of an outsole. The properties of the plurality of elements 104 may comprise an arrangement of the plurality of elements protruding from the base portion 102 of the outsole 100. For example, the position of each element 104 on the base portion 102 of the outsole 100 may be defined as a property. In some examples, the properties of the plurality of elements 104 may comprise a number of elements protruding from the base portion of the outsole. The properties, in some examples, may comprise a height of each of the plurality of elements. Thus, some elements 104 may protrude further from the base portion 102 than other elements. In some examples, the properties may comprise a density (e.g. an effective density) of build material used to form each of the plurality of elements 104. In this way, some elements 104 may be formed from a denser material, reducing the amount of wear experienced by those elements, thereby prolonging their life. The properties may comprise a weight of the outsole and/or a weight distribution of the outsole. As noted above, in some cases, it may be intended that the outsole is as lightweight as possible and, in other examples, it may be intended that the weight of the outsole is distributed towards one side of the outsole, for example to aid with correcting for pronation or supination.

In some examples, the properties of the plurality of elements may be uniform across the outsole; for example, the height of each of the plurality of elements may be the same. In other examples, the properties of each element of the plurality of elements 104 may be selected independently of other elements; for example, the height of a first element of the plurality of elements may be different to the height of a second element of the plurality of elements. In some examples, a first group or subset of elements may have a first property (e.g. a first height or structure) and a second group or subset of elements may have a second property (e.g. a second height or structure). In other examples, some elements of the plurality of elements may have different properties (e.g. a different height or structure) to other elements of the plurality of elements.

In some examples, a density of build material used to form each of the plurality of elements 104 may be the same, whereas, in other examples, the density of build material used to form the plurality of elements may vary across the elements. In some examples, the plurality of elements 104 may be arranged such that the elements are equidistant from one another, whereas, in other examples, the plurality of elements 104 may be arranged such that a distance between adjacent elements of the plurality of elements varies across the outsole. The arrangement of the plurality of elements may, in some examples, refer to an orientation of the elements; for example, a pair of elements may extend from the base portion 102 of the outsole 100 with a relative rotation, or translation (e.g. of 90 degrees) between them. In some examples, a weight of the outsole 100, and similarly a weight distribution of the outsole, may be varied by, for example, modifying a thickness of the base portion 102 of the outsole, a density of build material used to manufacture the base portion of the outsole, or by varying properties of the plurality of elements 104 extending from the base portion (e.g. by varying a number, density, size, height, or the like, of the plurality of elements). In some examples, a weight, and/or a weight distribution of an outsole, may be varied by varying a thickness and/or density of build material of the outsole across the outsole; for example, a back portion of the outsole may be thicker than a front portion of the outsole. The plurality of elements 104 may be arranged, or located, on the base portion 102 independently of one another (e.g. without being in contact with one another) or may be connected to one another by connecting portions, or a combination thereof. The properties (e.g. the height, weight, density, size, or the like) of the connecting portions may be the same as, or different to, the elements that the interconnecting portions are attached to.

As shown in the example of FIG. 1, an element or multiple elements of the plurality of elements 104 may comprise a texture 106. The texture 106, which may be referred to as a microtexture, may be applied to or formed on part of an element, such as an end surface of an element. Properties of the elements may define the texture to be applied to or formed on an element of the plurality of elements 102, and the texture may be applied to or formed on the end portion of the element, which is the element that is intended, during use, to encounter the ground. Properties defining the texture may be included in the data used by the additive manufacturing apparatus to generate the outsole, such that the texture, or multiple textures, may be formed on the intended elements during the additive manufacturing process. In some examples, the properties of an element, such as the end portion of an element (e.g. the texture), may define the form of the intended texture. For example, the properties may define that an element includes a structure or multiple structures, such as a bump, a hemisphere, a line or ridge, a protrusion or micro-protrusion, a recess, or the like, located or formed on part of an element, such as an end surface of an element of the plurality of elements, thereby contributing to a surface roughness and, therefore, grip, of each end surface having the texture. The texture applied to the end surface of each element may improve a grip associated with the outsole when the outsole is in contact with a surface (e.g. when a subject wearing an article of footwear comprising the outsole is performing an activity, such as running). Adding a texture to an end surface of an element or a subgroup of elements using an additive manufacturing apparatus can be achieved by including data defining the properties of the texture in the data defining the model of the outsole to be manufactured, and can be varied, or customized, for each article of footwear. For example, the texture can be varied for each subject, depending on their biometric data, can be varied in light of the activity to be performed, and/or can be varied in light of a user preference.

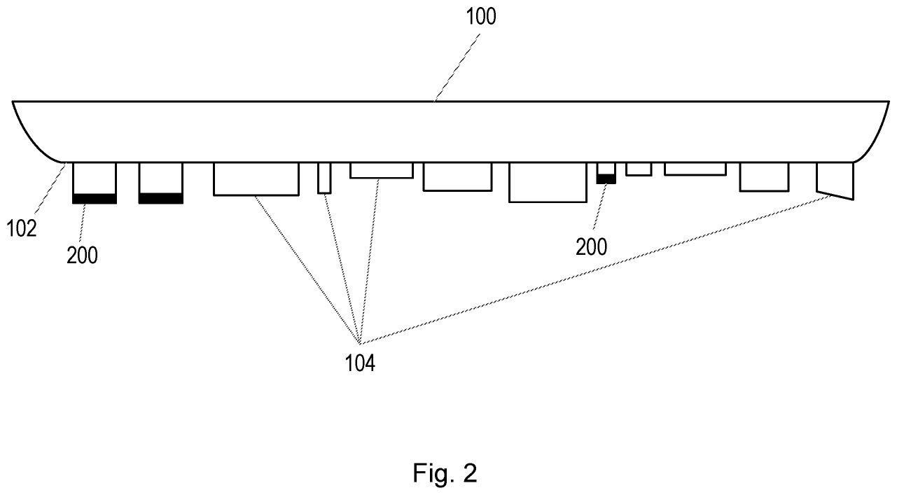

FIG. 2 is a simplified schematic of a further example of an outsole 100 of an article of footwear, comprising a base portion 102, a plurality of elements 104 extending from the base portion 102, and a texture applied to an end portion 200 of a subgroup of the plurality of elements. In some examples, all of the plurality of elements 104 may comprise an end portion 200 comprising a texture. According to the example shown in FIG. 2, a height of the plurality of elements 104 (i.e. an amount that an element extends from the base portion in a direction substantially perpendicular to the base portion 102) may differ. Similarly, in this example, a size (i.e. a cross-sectional width or length of the elements, in a direction substantially parallel to the base portion) of the plurality of elements may differ. In some examples, the plurality of elements 104 may be the same shape (i.e. the elements may comprise the same width, length and height) as one another, whereas, in other examples, some elements may be shaped differently from others. In some examples, an element (or multiple elements) of the plurality of elements 104 may comprise an angled portion (e.g. an angled surface) such that the end surface 200 of the element is not parallel with the base portion 102 of the outsole 100. During use, the end surfaces that are sloped or angled with respect to the base portion may partially engage the ground, such that part of each sloped end surface does not contact the ground.

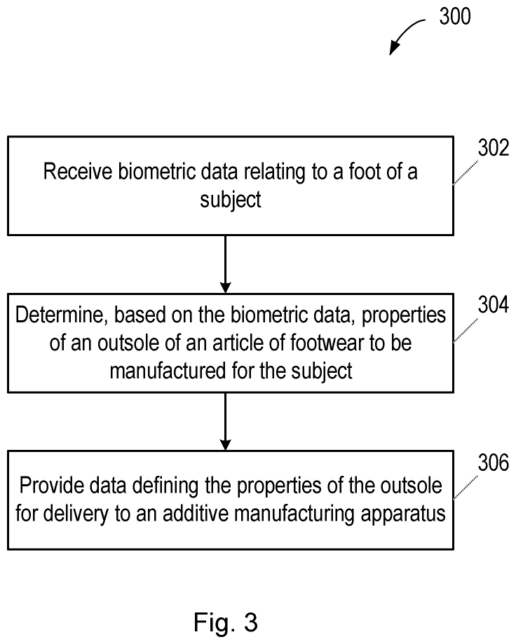

FIG. 3 is a flowchart of an example of a computer-implemented method 300 of determining properties of an outsole of an article of footwear. The method 300 comprises, at block 302, receiving biometric data relating to a foot of a subject. Biometric data relating to a foot is intended to refer to any data (e.g. biological or anatomical data) or information relating to a person's foot including, for example, the size or shape, and/or the pressure exerted by different regions of the foot onto a surface, for example when the person is standing or performing an activity. In some examples, the biometric data may be received by a processor (e.g. a processor of a computing system), and the processor may perform other parts of the methods discussed herein. For example, the biometric data may be sent to the processor (or the processor may retrieve the biometric data) from a server (e.g. a server or a computing device forming part of a cloud-computing system, or the like) based on previously-generated biometric data (e.g. based on biometric data associated with a subject that is stored on an electronic memory, such that no extra measurements are used in order to obtain the biometric data). In other examples, the biometric data may be obtained by a measurement system (e.g. an image capture device or a three-dimensional scanner for imaging, determining and/or measuring a shape or size of a foot of a subject), and the biometric data may move from the measurement system to the processor.

The biometric data may comprise data selected from a group comprising: biomechanical data relating to the subject, a shape of the foot, a footprint of the foot, an indication of downward pressure exerted at a plurality of regions of the foot when stationary, an indication of downward pressure exerted at a plurality of regions of the foot when performing an activity, a weight of the subject, a height of the subject, a footedness of the subject, an indication of a gait of the subject and a gender of the subject.

Biomechanical data relates to the mechanical laws concerning the movement or structure of living organisms and may be used to characterize human movement. A shape of the foot of a subject may comprise information relating to, for example, whether the subject is flat footed or has a high arch, or a degree to which the subject if flat footed or high arched. A footprint of the foot of a subject may comprise information relating to the size and shape of the subject's foot when the foot is in contact with a surface. An indication of downward pressure exerted at a plurality of regions of the foot when stationary refers to a pressure exerted by a point, or an area, of a subject's foot when the subject is, for example, standing upright and stationary (i.e. not moving). The downward pressure exerted by a subject's foot may be different at different areas of the subject's foot; for example, the downward pressure exerted by the area of a subject's foot underneath the heal of their foot is likely to be higher than the downward pressure exerted by a central area of the subject's foot. The downward pressure exerted by a subject's foot, and how the downward pressure varies across the profile of the subject's foot, when the subject is performing an activity is likely to change with time and is likely to be different to the downward pressure exerted when the subject is stationary. For example, the downward pressure exerted by an area of a subject's foot underneath their heel is likely to be higher than the downward pressure exerted by an area of the subject's foot underneath their toes when landing on a foot while running. Similarly, the downward pressure exerted by an area of a subject's foot is likely to be higher while performing an activity, such as running, compared to when the subject is stationary. A footedness of a subject refers to whether the subject is prone, or has a preference, to use one foot over the other (e.g. the chosen foot used to kick a football). An indication of a gait of a subject refers to the subject's manner of walking. Each of the factors described above may comprise information relating to which areas of an outsole 100 of an article of footwear are likely to be put under a higher pressure, or subject to higher wear and tear, and these can be accounted for when customizing the outsole.

The method 300 comprises, at block 304, determining, based on the biometric data, properties of an outsole of an article of footwear to be manufactured for the subject. The properties of an outsole may comprise properties selected from a group comprising: an arrangement of a plurality of elements protruding from the base portion of the outsole; a number of elements protruding from the base portion of the outsole; a height of each of the plurality of elements; a density of material (e.g. build material) used to form each of the plurality of elements; a weight of the outsole; a weight distribution of the outsole, a density of build material used to manufacture the outsole, a thickness of the outsole, a thickness profile of the outsole, a size of the outsole (i.e. a width and length profile of the outsole); and the like. In some examples, the properties of an outsole may comprise a shape of each of the plurality of elements (e.g. the cross-sectional shape). In some examples, the properties of an outsole may comprise a texture applied to each of the plurality of elements. In some examples, the properties of an outsole may comprise a color (e.g. a color of the base portion 102 and/or a color of a side portion of the outsole, which is visible when the article of footwear is in contact with the ground). Each of the properties discussed herein may be associated with a single element of the plurality of elements, a subgroup of the plurality of elements, or all of the plurality of elements.

Determining properties of an outsole 100 of an article of footwear (block 304) may be further based on properties of an insole of the article of footwear, or properties of a midsole of the article of footwear, or a combination thereof. Thus, in other words, the design or customization of the outsole may be based on the insole or midsole of the footwear.

In some examples, determining properties of an outsole of an article of footwear (block 304) may be further based on a level of interaction between the foot of the subject and the outsole 100 of the article of footwear. The level of interaction may, for example, be determined by or defined in terms of the downward pressure exerted by various parts of the foot while stationary and/or while performing an activity.

The method 300 comprises, at block 306, providing data defining the properties of the outsole for delivery to an additive manufacturing apparatus. For example, the data defining the properties may comprise object data or model data (e.g. in the form of a file capable of being read by the additive manufacturing apparatus) that can be used by the additive manufacturing apparatus to generate the outsole according to the data (i.e. incorporating the intended properties).

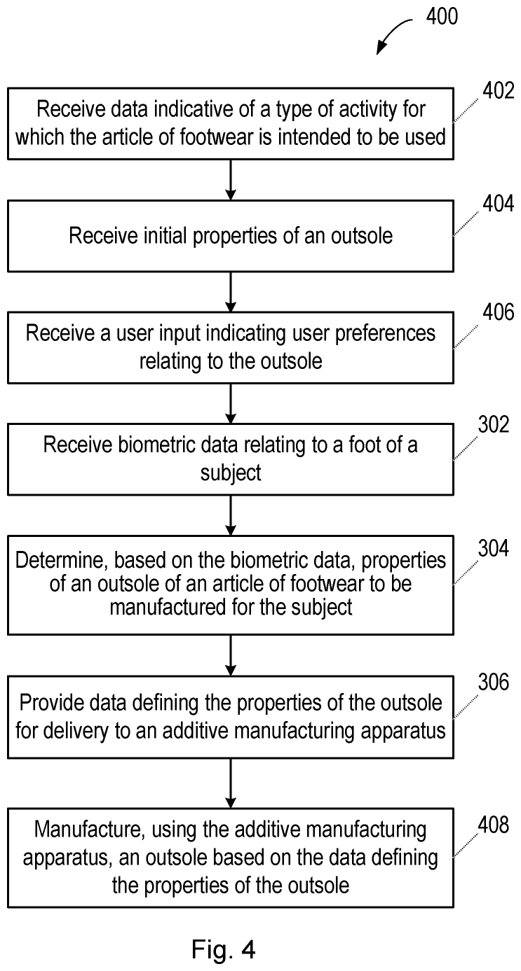

FIG. 4 is a flowchart of a further example of a method 400 of determining properties of an outsole of an article of footwear. The method 400, which may comprise a computer-implemented method, may comprise blocks of the method 300 discussed above. In some examples, the method 400 may comprise, at block 402, receiving data indicative of a type of activity for which the article of footwear is intended to be used. Determining properties of an outsole 100 at block 304 may be further based on the type of activity for which the article of footwear is intended to be used. For example, if an outsole is intended to be used for road running, properties may be determined differently than if the outsole is intended to be used for hiking over rocky terrain. In some examples, predefined properties for a range of different activities may be stored in a memory (e.g. in a database or look-up table) and used when determining appropriate properties (e.g. at block 304) based on the intended activity. In some examples, a library (e.g. a library stored in a memory of a computing device) may contain information relating an outsole design (e.g. properties of an outsole) to an activity, or activities, for which the outsole design is optimized.

At block 404, the method 400 may comprise receiving initial properties of an outsole. The initial properties may comprise a template or set of base properties which can be modified and adapted (e.g. customized) based on the biometric data and other data provided by and in respect of the subject. In some examples, determining the properties of the outsole (block 304) may comprise adapting the initial properties based on the received data indicative of a type of activity for which the article of footwear is intended to be used. In other examples, determining the properties of the outsole 100 may comprise adapting the initial properties based on the received biometric data. In some examples, determining the properties of the outsole 100 may comprise adapting the initial properties based on both the received data indicative of a type of activity for which the article of footwear is intended to be used and the received biometric data.

The initial properties of the outsole 100 may comprise a shape (e.g. an initial shape) of the outsole, a weight (e.g. an initial weight) of the outsole, and/or properties (e.g. initial properties) relating to the base portion 102 of the outsole 100, including, for example, an arrangement of a plurality of elements 104, a number of the plurality of elements, a density of build material with which the plurality of elements are to be manufactured, and the like. In some examples, the initial properties of the outsole 100 may relate to a generic outsole 100 (e.g. an outsole that is not specific to any particular activity or customized based on biometric data). In some examples, a generic outsole 100 may be an outsole that comprises a base portion 102 without elements extending from the base portion. In other examples, a generic outsole 100 may be an outsole that comprises a plurality of elements 104 extending from a base portion 102 of the outsole, wherein the plurality of elements are spaced at regular intervals, are of the same size, are to be made with a same density of build material, or the like. In other examples, a generic outsole 100 may be an outsole that is specific to a particular activity; for example, there may be a generic outsole for an article of footwear that is intended to be used for road running, whereas there may be another, different, generic outsole for an article of footwear that is intended to be used for hiking.

The initial properties of the outsole 100 may be adapted in a number of ways including, for example, modifying an arrangement of the plurality of elements extending from the base portion 102 of the outsole, modifying a number of elements protruding from the base portion of the outsole, modifying a size (e.g. a height, a width, or a length) of the plurality of elements, modifying a density of the build material with which each of the plurality of elements is to be manufactured, modifying a weight of the outsole, modifying a weight distribution of the outsole, modifying a density of build material used to manufacture the outsole, modifying a thickness of the outsole, modifying a thickness profile of the outsole, modifying a size of the outsole (i.e. a width and length profile of the outsole), modifying the texture applied to each of the plurality of elements (or modifying the texture applied to a subgroup of the plurality of elements), and the like. As disclosed herein, the initial properties of the outsole 100 may be adapted based on the biometric data associated with a subject.

As noted above, some customization may be made based on preferences of the user. Thus, at block 406, the method 400 may comprise receiving a user input indicating user preferences relating to the outsole 100. In such examples, determining properties of an outsole 100 (e.g. block 304) may be further based on the user preferences.

The method 400 may comprise, at block 408, manufacturing, using the additive manufacturing apparatus, an outsole 100 based on the data defining the properties of the outsole. Thus, the data provided to the additive manufacturing apparatus may be used to generate the outsole having the determined properties, and therefore customized based on the biometric data of the subject.

In some examples, the methods 300, 400 may comprise generating a template, or a generic model, of an outsole 100. The methods 300, 400 may further comprise adapting the template, or generic model, based on: the received biometric data associated with a subject, an activity with which the subject intends to perform while wearing the article of footwear, and/or based on the user preferences relating to the outsole. In other examples, the methods 300, 400 may comprise determining 304 properties of the outsole 100 of an article of footwear from scratch (i.e. without receiving, or being based on, any initial properties of the outsole).

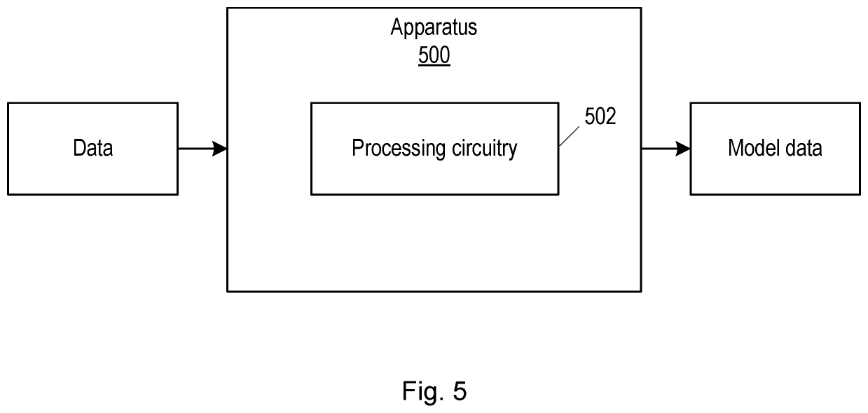

Examples disclosed herein also relate to an apparatus, such as an apparatus capable of performing the methods 300, 400 disclosed herein. FIG. 5 is a schematic illustration of an example of an apparatus 500. The apparatus 500 may comprise an apparatus for establishing structural characteristics of an outsole 100 of an article of footwear. The apparatus 500 comprises processing circuitry 502, such as the processor discussed above. The processing circuitry 502 may perform blocks of the methods 300, 400 disclosed herein. In the example shown in FIG. 5, the processing circuitry 502 is to obtain data indicative of a biometric property of a foot of a subject. The processing circuitry 502 is further to establish, based on the biometric property, structural characteristics of an outsole 100 of an article of footwear, which is to be formed using an additive manufacturing apparatus. In some examples, just the outsole 100 is to be formed using the additive manufacturing apparatus. In other examples, the article of footwear, including the outsole, may be formed using the additive manufacturing apparatus. The processing circuitry 502 is further to generate model data representing the outsole 100 and incorporating the established structural characteristics, the model data to be used by the additive manufacturing apparatus to form the outsole 100 during an additive manufacturing process.

In some examples, the structural characteristics of an outsole 100 may be the same as the properties of the outsole described previously, for example relating to an arrangement of a plurality of elements protruding from a base portion 102 of the outsole 100; a number of elements protruding from the base portion of the outsole; a height of each of the plurality of elements; a density of build material used to form each of the plurality of elements; a weight of the outsole; and a weight distribution of the outsole. In other examples, the structural characteristics of an outsole 100 may refer to physical properties of the outsole, such as an elasticity, malleability, stiffness, flexibility, or the like.

In some examples, the apparatus 500 may comprise an additive manufacturing apparatus. The processing circuitry 502 may be suitable for operating the additive manufacturing apparatus to form an outsole 100, based on the generated model data.

In some examples, the biometric data relating to a foot of a subject may comprise pressure data indicative of downward pressure exerted by a plurality of regions of the foot of the subject. The pressure data may be acquired using a pressure sensing device, such as a pressure pad. The biometric data may, in some examples, comprise geometrical data relating to the foot, such as data indicative of the size and/or shape of the subject's foot. The geometrical data may, for example, be acquired using an image capture device. In some examples, a subject may capture an image of their foot using a camera, such as the camera of a smartphone. Such an image capture device may include depth data and/or may be capable of providing a three-dimensional image of the foot.

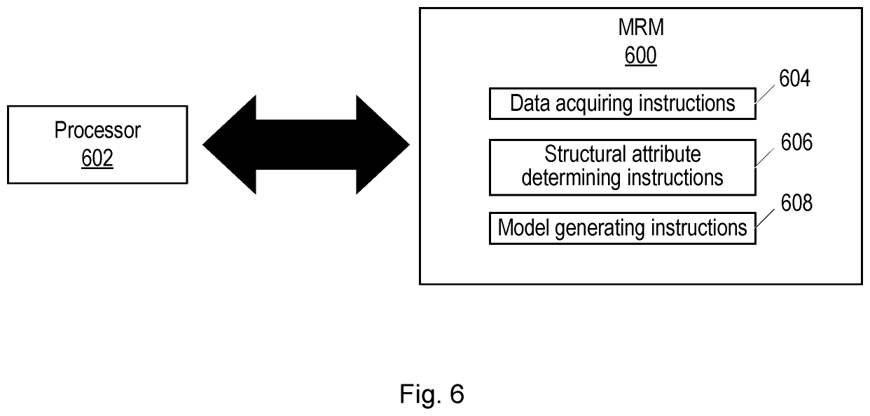

Examples disclosed herein also relate to a machine-readable medium. FIG. 6 is a schematic illustration of a processor 602 in communication with a machine-readable medium 600. The machine-readable medium 600 comprises instructions which, when executed by the processor 602, cause the processor to perform the blocks of the methods 300, 400 disclosed herein. The machine-readable medium 600 comprises instructions (e.g. data acquiring instructions 604) which, when executed by the processor 602, cause the processor to acquire data describing a biometric feature of a foot of a subject. The machine-readable medium 600 further comprises instructions (e.g. structural attribute determining instructions 606) which, when executed by the processor 602, cause the processor to determine, based on the acquired data, structural attributes of an outsole 100 of an article of footwear. The machine-readable medium 600 further comprises instructions (e.g. model generating instructions 608) which, when executed by the processor 602, cause the processor to generate, based on the attributes of the outsole 100, model data representing an outsole, the model data to be used by an additive manufacturing apparatus to generate an outsole according to the model data.

In some examples, the machine-readable medium 600 may comprise instructions which, when executed by the processor 602, cause the processor to acquire data describing a biometric feature of a foot of a subject comprising data selected from a group comprising: three-dimensional shape data indicative of a shape of the foot of the subject; static pressure data indicative of downward pressure exerted by a plurality of regions of the foot of the subject when the foot is static; and dynamic pressure data indicative of downward pressure exerted by a plurality of regions of the foot of the subject when the foot is moving. The static data may comprise data acquired when the subject is standing still (e.g. stationary) and the dynamic data may comprise data acquired when the subject is performing an activity (for example walking or running).

In some examples, the machine-readable medium 600 may comprise instructions which, when executed by a processor 602, cause the processor to: determine, based on the acquired data, a sole texture to be applied to a surface of the outsole 100; and generate model data representing an outsole further based on the determined sole texture. The sole texture may comprise a texture to be applied to part of the outsole (e.g. to an end surface of an element protruding from the base portion) or to all of the outsole's surface that is intended to contact the ground during use.

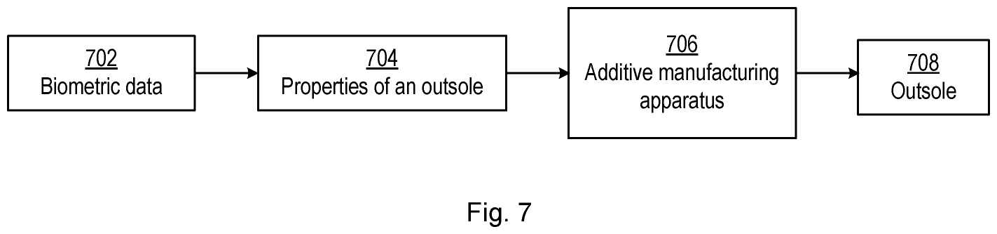

According to the present disclosure, an outsole may be provided. The outsole may comprise an outsole manufactured using blocks of the methods 300, 400 disclosed herein and/or using the apparatus 500 disclosed herein. FIG. 7 is a flowchart showing a further example of a process for forming an outsole 100, 708. According to some examples, an outsole 100, 708 may be obtainable by: receiving biometric data 702 relating to a foot of a subject; determining, based on the biometric data, properties 704 of an outsole of an article of footwear to be manufactured for the subject; providing data defining the properties of the outsole for delivery to an additive manufacturing apparatus 706; and manufacturing, using the additive manufacturing apparatus, the outsole 708 based on the data defining the properties of the outsole. In other examples, the outsole 100, 708 may comprise an outsole generated by an additive manufacturing apparatus 706, using data defining properties 704 of the outsole, the properties based on biometric data 702 relating to a foot of a subject who is to wear an article of footwear that incorporates the outsole.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A computer-implemented method comprising:
receiving biometric data relating to a foot of a subject;
determining, based on the biometric data, properties of an outsole of an article of footwear to be manufactured for the subject; and
providing data defining the properties of the outsole for delivery to an additive manufacturing apparatus.

2. A method according to claim 1, further comprising:
manufacturing, using the additive manufacturing apparatus, an outsole based on the data defining the properties of the outsole.

3. A method according to claim 1, further comprising:
receiving data indicative of a type of activity for which the article of footwear is intended to be used;
wherein determining properties of an outsole is further based on the type of activity for which the article of footwear is intended to be used.

4. A method according to claim 3, further comprising:
receiving initial properties of an outsole;
wherein determining the properties of the outsole comprises adapting the initial properties based on the received data indicative of a type of activity for which the article of footwear is intended to be used.

5. A method according to claim 1, further comprising:
receiving initial properties of an outsole;
wherein determining the properties of the outsole comprises adapting the initial properties based on the received biometric data.

6. A method according to claim 1, wherein the biometric data comprises data selected from a group comprising: biomechanical data relating to the subject, a shape of the foot, a footprint of the foot, an indication of downward pressure exerted at a plurality of regions of the foot when stationary, an indication of downward pressure exerted at a plurality of regions of the foot when performing an activity, a weight of the subject, a height of the subject, a footedness of the subject, an indication of a gait of the subject and a gender of the subject.

7. A method according to claim 1, wherein the outsole comprises a base portion and a plurality of elements extending from the base portion; and
wherein the properties of the outsole comprise properties selected from a group comprising: an arrangement of a plurality of elements protruding from the base portion of the outsole; a number of elements protruding from the base portion of the outsole; a height of each of the plurality of elements; a density of build material used to form each of the plurality of elements; a weight of the outsole; and a weight distribution of the outsole.

8. A method according to claim 7, wherein each element of the plurality of elements comprises an end surface; and
wherein the properties of the outsole further comprise properties defining a texture to be applied to the end surface of each element of the plurality of elements.

9. A method according to claim 1, wherein determining properties of an outsole of an article of footwear is further based on a level of interaction between the foot of the subject and the outsole of the article of footwear.

10. A method according to claim 1, further comprising:
receiving a user input indicating user preferences relating to the outsole;
wherein determining properties of an outsole is further based on the user preferences.

11. An apparatus, comprising:
a processor to:
obtain data indicative of a biometric property of a foot of a subject;
establish, based on the biometric property, structural characteristics of an outsole of an article of footwear, which is to be formed using an additive manufacturing apparatus; and
generate model data representing the outsole and incorporating the established structural characteristics, the model data to be used by the additive manufacturing apparatus to form the outsole during an additive manufacturing process.

12. An apparatus according to claim 11, wherein the apparatus comprises an additive manufacturing apparatus; and
wherein the processor is to:
operate the additive manufacturing apparatus to form an outsole based on the generated model data.

13. An apparatus according to claim 11, wherein the biometric data relating to a foot of a subject comprises data selected from a group comprising: pressure data indicative of downward pressure exerted by a plurality of regions of the foot of the subject, the pressure data acquired using a pressure sensing device; and geometrical data relating to the foot, the geometrical data acquired using an image capture device.

14. A machine-readable medium comprising instructions which, when executed by a processor, cause the processor to:
acquire data describing a biometric feature of a foot of a subject;
determine, based on the acquired data, structural attributes of an outsole of an article of footwear; and
generate, based on the attributes of the outsole, model data representing an outsole, the model data to be used by an additive manufacturing apparatus to generate an outsole according to the model data.

15. An outsole obtainable by:
receiving biometric data relating to a foot of a subject;
determining, based on the biometric data, properties of an outsole of an article of footwear to be manufactured for the subject;
providing data defining the properties of the outsole for delivery to an additive manufacturing apparatus; and
manufacturing, using the additive manufacturing apparatus, the outsole based on the data defining the properties of the outsole.
